(19) United States
(12) Patent Application Publication
(10) Pub. No.: US 2010/0115989 A1
(43) Pub. Date: May 13, 2010

(54) APPARATUS AND METHOD FOR PRODUCING POTABLE WATER

(76) Inventors: Zenon Chrysostomou, Paphos (CY); Evagoras Nikolaou, Rodhes Island (GR)

Correspondence Address: FRANCIS EDWARD MARINO, 394 MEREDITH NECK ROAD, MEREDITH, NH, 03253, US

(21) Appl. No.: 12/467,376

(22) Filed: May 18, 2009

Related U.S. Application Data
(60) Provisional application No. 61/114,079, filed on Nov. 13, 2008.

(51) Int. Cl. C02F 1/22; F25D 3/00; F25B 29/00

(52) U.S. Cl. 62/541; 62/318; 165/61

(57) ABSTRACT

An exemplary device and method for removing undesired substances from original water comprises a cooling circuit for cooling the original water to or below approximately Zero degrees Celsius, whereby the saturation level of the undesired substances in the original water is exceeded, thereby causing segregation of the original water into purified ice, undesired precipitated solids, and a waste liquid containing the remaining undesired substances (soluble salts). Means for removing the waste liquid from the purified ice, a heating circuit for melting the purified ice into purified water, a reservoir having an inlet for receiving the original water and an outlet for dispensing the purified water, and a first water purity monitor disposed adjacent the outlet for monitoring a first purity level of the purified water are provided.

### RELATED APPLICATION

This application is a Continuation of, and claims the benefit of, pending U.S. Provisional application Ser. No. 61/114,079, filed Nov. 13, 2008, and the entire teachings of which are incorporated herein by reference.

### FIELD OF THE INVENTION

The field of the present invention includes water purification. More specifically, the field includes devices, systems, and methods for purifying salty, hard, or otherwise impure water.

### SUMMARY OF THE INVENTION

The present invention may be embodied as a device, system, or method for producing purified water from salty, hard, or otherwise impure original water through a freezing and thawing process employing a closed refrigeration circuit. The refrigeration circuit may be, but is not limited to, a heat pump refrigeration circuit such as those used in an in-home refrigerators. Such a system may operate on household electricity to best enable its use as an in-home appliance. The device and method of the exemplary embodiment disclosed herein allows alteration of the purification process according to the qualities of the original water and desired purpose for the resulting water.

The invention may be embodied in a device for removing undesired substances from original water comprising a cooling circuit for cooling the original water to or below approximately Zero degrees Celsius whereby the saturation level of the undesired substances in the original water is exceeded, thereby causing segregation of the original water into purified ice, undesired precipitated solids, and a waste liquid containing the remaining undesired substances (soluble salts).

The device may have means for removing the undesired precipitated solids and the waste liquid from the purified ice, a heating circuit for melting the purified ice into purified water, and a reservoir having an inlet for receiving the original water and an outlet for dispensing the purified water.

The device may have a first water purity monitor disposed adjacent the outlet for monitoring a first purity level of the purified water, a controller for controlling the cooling and heating circuits according to the first purity level, and a second water purity monitor disposed adjacent the inlet for monitoring a second purity level of the original water, and a controller for controlling the cooling and heating circuits according to the second purity level. The controller may further control the cooling and heating circuits according to a comparison of the first and second purity levels.

The device may further have a selector for selecting a desired value of the first purity level, wherein the controller controls the cooling and heating circuits to cause the purified water to be dispensed at the desired value. The device may have a mechanical filter in communication with the outlet to filter remaining impurities from the purified water. The device may have a diverter for selectably causing the purified water to be dispensed either directly from the outlet or through the mechanical filter.

The invention may be embodied as a method for removing undesired substances from original water to produce purified water comprising the steps of;
providing a reservoir having an inlet for receiving the original water and an outlet for dispensing the purified water;
providing a first water purity monitor disposed adjacent the outlet; cooling the original water in the reservoir to or below approximately Zero degrees Celsius whereby the saturation level of the undesired substances in the original water is exceeded, thereby causing segregation of the original water into purified ice, undesired precipitated solids, and a waste liquid containing the undesired substances;
removing the waste liquid from the purified ice; melting the purified ice into the purified water; and
monitoring a first purity level of the purified water with the first water purity monitor.

The method may further comprise providing a controller for controlling the cooling and heating, and controlling the cooling and heating with the controller according to the first purity level. The method may further comprise providing a second water purity monitor disposed adjacent the inlet, and monitoring a second purity level of the original water with the second water purity monitor.

The method may further comprise controlling the cooling and heating with the controller according to the second purity level. The method may further comprise controlling the heating and cooling with the controller according to a comparison of the first and second purity levels. The method may further comprise providing a selector for selecting a desired value of the first purity level, selecting the desired level of the first purity level with the selector, and controlling the cooling and heating with the controller to cause the purified water to be dispensed at the desired value.

The method may further comprise providing a mechanical filter in communication with the outlet, and filtering remaining impurities from the purified water with the mechanical filter. The method may further comprise providing means for selectably causing the purified water to be dispensed either directly from the outlet or through the mechanical filter, and actuating the means to select between causing the purified water to be dispensed directly from the outlet or causing the purified water to be dispensed through the mechanical filter.

The invention may further be embodied as a device for removing undesired substances from original water using a closed-loop refrigeration circuit and comprising a cooling portion of the closed-loop refrigeration circuit for cooling the original water to or below approximately Zero degrees Celsius whereby the saturation level of the undesired substances in the original water is exceeded, thereby causing segregation of the original water into purified ice, undesired precipitated solids, and a waste liquid containing the undesired substances.

The device may have means for removing the undesired precipitated solids and the waste liquid from the purified ice, a heating portion of the closed-loop refrigeration circuit for melting the purified ice into purified water, a reservoir having an inlet for receiving the original water and an outlet for dispensing the purified water, and a first water purity monitor disposed adjacent the outlet for monitoring a first purity level of the purified water.

The device may further comprise a controller for controlling the cooling and heating portions according to the first purity level. The device may further comprise a second water purity monitor disposed adjacent the inlet for monitoring a second purity level of the original water. The device may further comprise a controller for controlling the cooling and heating portions according to the second purity level. The controller may further control the cooling and heating portions according to a comparison of the first and second purity levels.

The device may further comprise a selector for selecting a desired value of the first purity level, wherein the controller controls the cooling and heating portions to cause the purified water to be dispensed at the desired value. The device may further comprise a mechanical filter in communication with the outlet to filter remaining impurities from the purified water. The device may further comprise means for selectably causing the purified water to be dispensed either directly from the outlet or through the mechanical filter.

The closed-loop refrigeration circuit may contain a refrigerant and the heating portion may comprise a compressor for heating the refrigerant by compression thereof to melt the purified ice, and the cooling portion may comprise an expansion coil for cooling the refrigerant by allowing the expansion thereof to cool the original water.

### BACKGROUND

There exists a continuing need to reduce the salinity of sea water, to increase the softness of hard water, or to increase the purity of impure water, for various purposes. Such purposes include, but are not limited to, the production of clean water for washing and household use, the production of potable water for cooking, the production of pure water for drinking, and the production of ultra-pure water for certain industrial and medical uses. Each of these purposes requires a resulting water of a different level of purity.

The purification of water from sea water or hard water is a time-consuming and expensive task. There is a benefit to reducing the time and expense of such purification. However, the purity of the resulting water and the expense of producing it are directly proportional to the time of the purification process. Resulting water purity and expense are reduced with a reduction in the purification time. But simply reducing the time and thereby producing a resulting water of insufficient purity for the desired purpose is not acceptable.

Additionally, the time and expense of purification of water from sea water, hard water, or otherwise impure water, regardless of the desired purpose, is directly proportional to the salinity, hardness, or impurity level of the original water. It simply takes more time to purify water to any desired level when it is originally saltier, harder, or more impure than when it is originally less salty, less hard, or less impure.

Many devices and systems for attempting to purify salty or hard water are known, but have a variety of drawbacks and failings. As examples, U.S. Pat. Nos. 4,164,854, 3,587,240, 3,630,042, 3,367,123, 3,069,864, and 1,931,347 describe various desalinization systems and methods having no ability to allow alteration of the purification process according to the qualities of the original water or the desired purpose for the resulting water.

There exists the need, and such is an object of the present invention, for a water purification system or process that allows alteration of the purification process according to the qualities of the original water, for reasons including the minimization of the time and expense to only what is needed according to the instant need.

There exists the need, and such is an object of the present invention, for a water purification system or process that allows alteration of the purification process according to the desired purpose for the resulting water, for reasons including to minimization of the time and expense to only what is needed according thereto.

There exists the need, and such is an object of the present invention, for a water purification system or process that allows alteration of the purification process according to the qualities of the original water and the desired purpose of the resulting water, for reasons including the minimization of the time and expense to only what is needed according thereto.

There exists the need, and such is an object of the present invention, to provide a more effective and efficient home appliance capable of purifying original water such as sea water, hard water, or otherwise impure water.

There exists the need, and such is an object of the present invention, to provide an effective and efficient home appliance capable of purifying original water such as sea water, hard water, or otherwise impure water that allows alteration of the purification process according to the qualities of the original water, for reasons including the minimization of the time and expense to only what is needed according thereto.

There exists the need, and such is an object of the present invention, to provide an effective and efficient home appliance capable of purifying original water such as sea water, hard water, or otherwise impure water that allows alteration of the purification process according to the desired purpose for the resulting water, for reasons including to minimization of the time and expense to only what is needed according thereto.

There exists the need, and such is an object of the present invention, to provide an effective and efficient home appliance capable of purifying original water such as sea water, hard water, or otherwise impure water that allows alteration of the purification process according to both the qualities of the original water and the desired purpose of the resulting water, for reasons including the minimization of the time and expense to only what is needed according thereto.

There exists the need, and such is an object of the present invention, to provide a more effective and efficient method for purifying original water such as sea water, hard water, or otherwise impure water.

There exists the need, and such is an object of the present invention, to provide an effective and efficient method for purifying original water such as sea water, hard water, or otherwise impure water that allows alteration of the purification process according to the qualities of the original water, for reasons including the minimization of the time and expense to only what is needed according thereto.

There exists the need, and such is an object of the present invention, to provide an effective and efficient method for purifying original water such as sea water, hard water, or otherwise impure water that allows alteration of the purification process according to the desired purpose for the resulting water, for reasons including to minimization of the time and expense to only what is needed according thereto.

There exists the need, and such is an object of the present invention, to provide an effective and efficient method for purifying original water such as sea water, hard water, or otherwise impure water that allows alteration of the purification process according to the qualities of the original water and the desired purpose of the resulting water, for reasons including the minimization of the time and expense to only what is needed according thereto.

Further objects and advantages of the invention will become apparent in view of the following disclosure of an exemplary embodiment thereof and drawings related thereto.

### BRIEF DESCRIPTION OF THE DRAWINGS

FIG. 1 shows an apparatus according to an exemplary embodiment of the invention;

FIG. 2 is a schematic diagram of the apparatus of FIG. 1;

FIG. 3A is a diagram of a typical Heat Pump operating in cooling mode;

FIG. 3B is a diagram of a typical Heat Pump operating in heating mode;

FIG. 4 is a graph of the conductivity of output water according to the brine conductivity during a purification cycle using the apparatus of FIG. 1;

FIG. 5 is a chart of process information for various purification cycles using the apparatus of FIG. 1; and

FIG. 6 shows a cascaded arrangement connecting components of the apparatus of FIG. 1 in series.

### DETAILED DESCRIPTION OF PREFERRED EMBODIMENTS

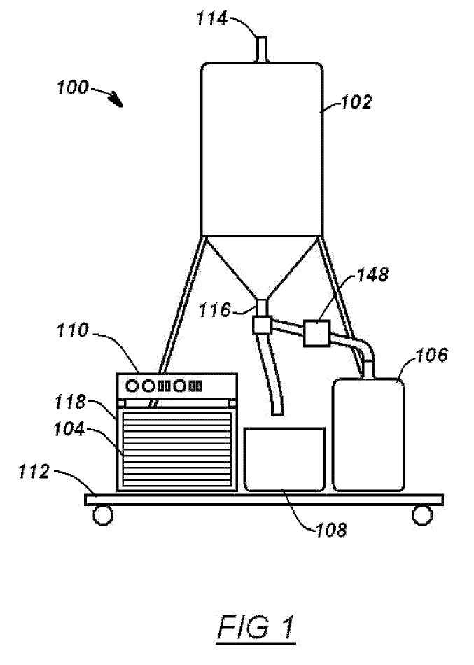

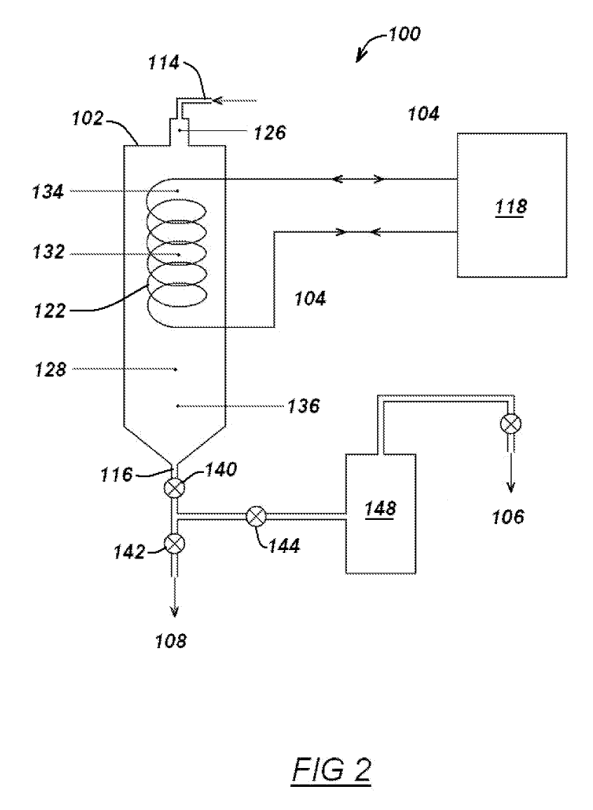

A first exemplary embodiment for practicing an apparatus and method for producing potable water in accordance with the invention is now described and shown in FIGS. 1 and 2, where there is shown purification system 100.

The main components of system 100 are a process water holding tank 102, a heating and cooling system 104, and a purified water holding tank 106. Additional components of the exemplary embodiment include a waste water holding tank 108, a controller 110, a micro filter 148, and a mobile cart 112.

The process water holding tank 102 is preferably constructed of stainless steel, with a capacity of approximately 30 litres. A process water inlet 114 is disposed adjacent the top of the tank and an outlet 116 is disposed at the base of the tank.

The cooling and heating system 104 is preferably a reversible heat pump similar to those used in certain home refrigerators, allowing the reversal of the refrigerant in order to switch between the cooling and heating modes. The heat pump includes a compressor/evaporator unit 118 disposed remotely from the process water holding tank 102 and in communication with a thermal transfer coil 122 disposed within the process water holding tank 102. No dangerous flames or chemicals need be used and the heating, no fumes are created or exhausted, and cooling requires only a household electricity supply.

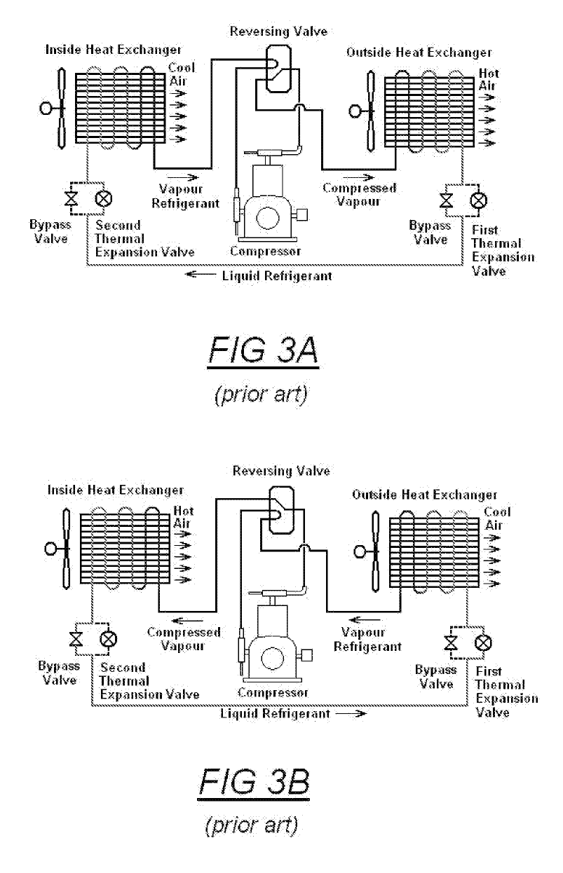

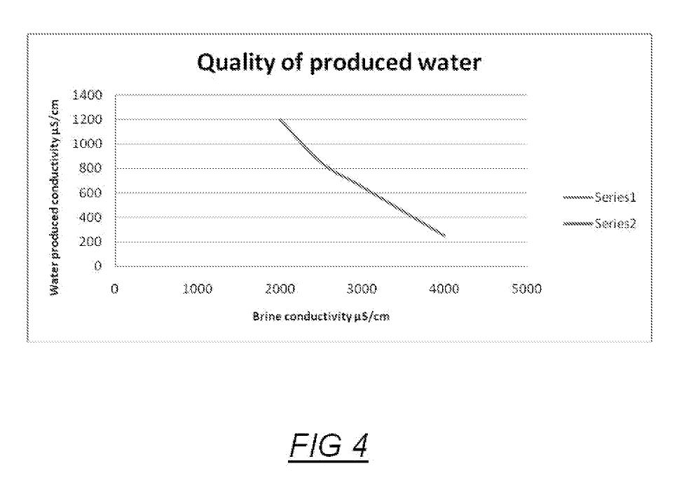

An explanatory description of the heat pump process is provided by the Singapore National Energy Efficiency Committee and published at
http://www.nccc.gov.sg/building/heat_pump.shtm,
   which is excerpted below with reference to FIGS. 3A and 3B;

Heat Pumps
Heat pumps are commonly used in temperate countries to provide premises with cooling in summer and heating in winter. It employs the concept of reversing the refrigerating cycle as detailed below.

Working Principles of Heat Pumps
Both heating and cooling modes of heat pumps do exactly the same thing. They “pump” the heat from one location to another. In these examples the heat in the air is moved out of or into the space.

Cooling Mode
A heat pump is essentially an air conditioner with a few additions, namely a reversing valve, two thermal expansion valves and two bypass valves. The reversible selection allows the unit to provide both cooling and heating. FIG. 3A shows a heat pump in cooling mode. The unit operates as follows:
The compressor compresses the refrigerant vapor and pumps it to the reversing valve.
The reversing valve directs the compressed vapor to flow to the outside heat exchanger (condenser) where the refrigerant is cooled and condensed to liquid.
The air blowing through the condenser coil removes heat from the refrigerant.
The liquid refrigerant bypasses the first thermal expansion valve and flows to the second thermal expansion valve at the inside heat exchanger (evaporator) where it expands into the evaporator and become vapor.
The refrigerant picks up heat energy from the air blowing across the evaporator coil and cool air comes out at the other side of the coil. The cool air is ducted to the occupied space as air-conditioned air.
The refrigerant vapor then goes back to the reversing valve to be directed to the compressor to start the refrigeration cycle all over again.

Heating Mode;
FIG. 3B shows the heat pump in heating mode. The difference between the two diagrams is the reversing valve directs the compressed vapor refrigerant to the inside heat exchanger first. This makes the inside heat exchanger to act as the condenser and gives out the heat energy. The heat is transferred to the air that blows across the coil and the heated air is ducted to the occupied space. The outside heat exchanger now becomes the evaporator. The liquid refrigerant bypasses the second thermal expansion valve and flows to the first thermal expansion valve where it expands into the evaporator. It becomes vapor and absorbs heat from the outside air. When the heat from inside coil is used to increase the temperature of water in a storage tank, the heat pump acts as a hot water generator. This can be achieved by using a heat exchanger to absorb heat from the inside coil with water circulating through it or by placing the inside coil in the storage tank.

In the instant application of heat pumping, the “occupied space” is replaced by the process water within tank 102 and the “inside heat exchanger” and associated air blower are replaced by the thermal transfer coil 122 in direct contact with the process water.

Controller 110 monitors and controls functions of the system, including the operation of valves, timing, sensing process conditions, and heating/cooling in cooperation with the sensed conditions, or according to time.

Tank 102 is filled with process water through inlet 114. The process water may be one or a combination of sea water, brine, hard water, or water containing other impurities which will drop out of solution as the process water is cooled to the approximately Zero degrees Celsius. Upper conductivity sensor 126 is disposed adjacent inlet 114 and measures the conductivity of the incoming process water, thereby establishing its impurity level, and communicates the same to the controller 110.

Lower thermal sensor 128 is positioned within a lower portion of tank 102 and communicates the temperature of the process water there-at to the controller 110. Mid-level thermal sensor 132 is positioned within a mid-level portion of tank 102 and communicates the temperature of the process water there-at to the controller 110. Upper thermal sensor 134 is positioned within an upper portion of tank 102 and communicates the temperature of the process water there-at to the controller 110.

Lower conductivity sensor 136 is disposed within a lower portion of tank 102 approximate outlet 116 and measures the conductivity of the process water there-at, thereby establishing its impurity level, and communicates the same to the controller 110.

After filling of tank 102 with process water is complete, controller 110 causes the cooling heating and cooling system 104 to initiate cooling of the process water. As the process water temperature drops below approximately Four degrees Celsius thermal stratification will occur, causing the cooler water to rise within the tank. Stratification is recognized by mid-level thermal sensor 132. Ice will form within the process water in the upper portion of tank 102, mostly from the water component thereof, as the lower thermal sensor 128 detects temperatures of Zero to Four degrees Celsius. At this point, thermal sensors 128 and 134 will sense temperatures at or below approximately Zero degrees Celsius and report the same to controller 110. The impurities within the process water will become insoluble and accumulate within a more and more concentrated solution, hereafter referred to as “brine”, in the bottom portion of tank 102, sensed by conductivity sensor 136 and reported to controller 110.

When the conductivity at sensor 136 reaches the pre-selected value, or when a predetermined time has elapsed, controller 110 terminates the cooling process and opens outlet valve 140 and brine valve 142, while maintaining pure water valve 144 in a closed state, to allow the undesired precipitated solids and the concentrated brine to drain directly into waste water holding tank 108. The ice crystals and a pre-calculated volume of the concentrated brine remaining inside tank 102 are comprised of a somewhat purified water of the desired conductivity.

Upon draining of the brine, the controller causes closure of valve 140 and reversal of the heating and cooling system 104 to the heating mode to melt the ice into a liquid water that is less impure than the original process water. Once the ice is fully melted, as sensed by sensor 128, its conductivity is reported to controller 110 by sensor 136. If the conductivity indicates that the process water has been purified to the desired level, controller 110 causes closing of valve 142 and opening of valves 140 and 144 to allow the purified water to flow through an optional 0.2 μm filter 148 for removal of impurities not already removed and into purified water holding tank 106 where it may be used as desired.

The temperature sensed at sensor 128 and the conductivity sensed at sensor 136 are used by controller 110, as adjusted by the user to regulate the heating and cooling process according to the desired output water quality. The process may be manually controlled by setting the controller to allow the user to determine values such as output water purity, reduction of purity from the input process water, or the volume of purified water desired. The amount of time required to purify input water of various conductivities and temperatures into output water of various purity levels can be predetermined and the system can be timed to operate accordingly.

Alternatively, the controller can be set such that the output quality and volume of both the brine and purified water may be controlled automatically by comparison of the conductivity and/or temperature of the incoming process water to the desired purity of the purified water using the measured parameters from the sensors. Thus, the system can more efficiently operate according to the qualities of the original process water and/or desired qualities of the purified water according to its own measurements and control.

All working conditions are regulated by the controller 110 according to the readings of the thermal sensors 128, 132, and 134 and conductivity sensors 126 and 136.

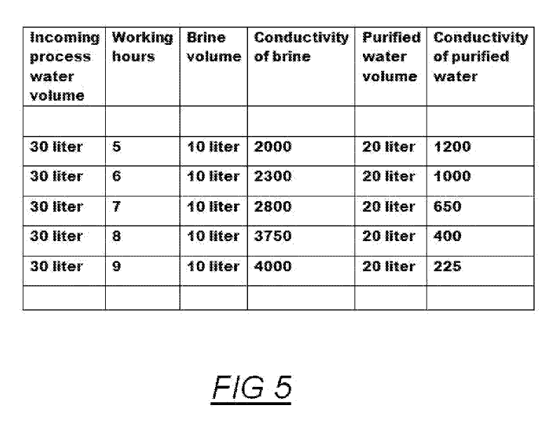

FIG. 4 is a graph depicting the conductivity (reciprocal of purity) of output water according to the brine conductivity of actual purification cycles using the apparatus. For this demonstration, the initial conductivity of the water was 1500 μs/cm. ten litres of brine with conductivities shown on the horizontal axis were removed from the tank after each purification cycle. The vertical axis shows the conductivity of the produced drinkable water. To obtain the lower conductivities of the output water and the greater conductivities of the removed brine, a greater process time is of course required. Initial conductivity of the water was 1500 μs/cm.

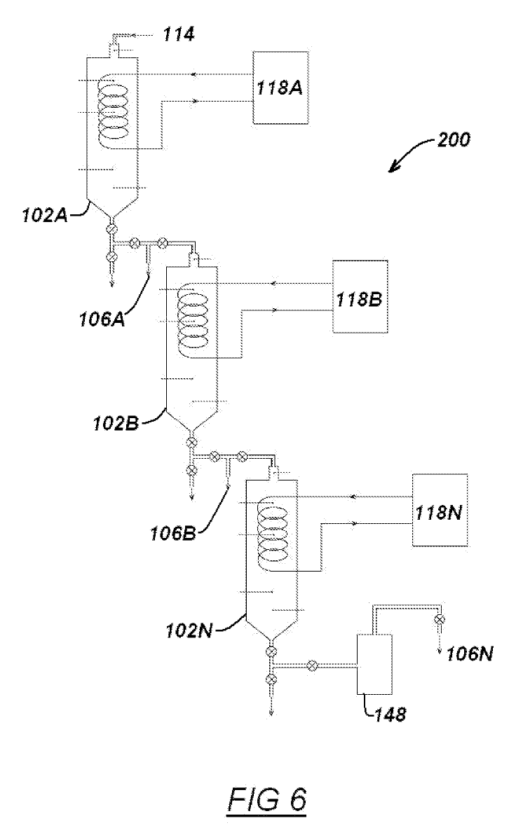

FIG. 5 is a chart of process information for various purification cycles using the apparatus and incoming process water having a conductivity of 1500 μs/cm.

As can be seen, the final purity of output water is flexible and regulated according to the needs of the use. In situations where water higher volume is needed and water quality can be sacrificed, such as for washing or toilet use, the system can automatically alter parameters accordingly so that time and energy are not wasted and water volume is not lost unnecessarily. In cases where maximum water purity is needed, such as for drinking or medical applications, the controller can be set to repeat the cooling/draw-off/heating cycle continuously until the needed purity level is reached, at the expense of water volume and energy consumption.

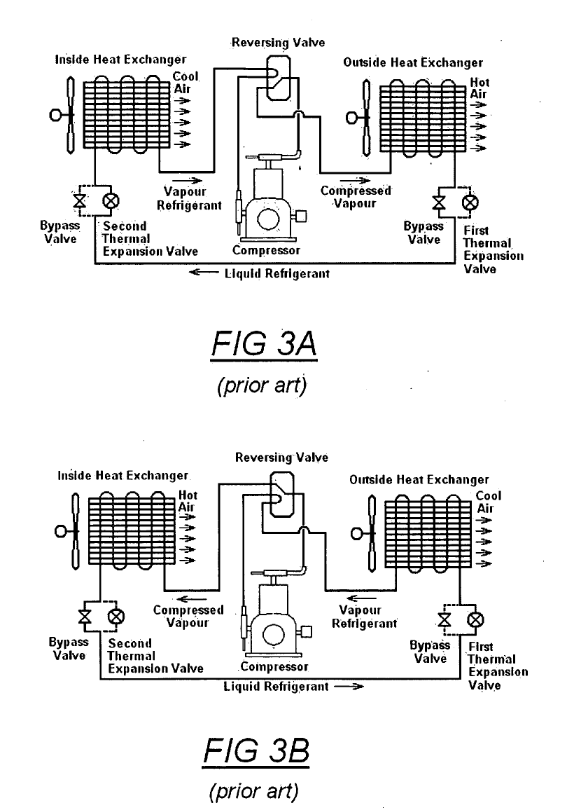

As shown in FIG. 6, a second embodiment of the invention is shown in system 200 having multiple quantities of components from apparatus 100 of the first embodiment configured in a cascaded arrangement, using a common controller, to continuously purify water in a staged process. The first process water holding tank 102A is used for a primary conductivity reduction, then sends its water to a second process water holding tank 102B rather than a purified water holding tank for a secondary conductivity reduction, and so on to Nth process water holding tank 102N. Some water may be drawn off at outlets 106A through 106N for use according to various needs. In this way a continuous supply of waters of increasing purity is always available instantly at the expense of energy consumption and system cost.

It should be understood that, while FIG. 6 shows a cascading of three stages, it is intended that any number of stages may be cascaded, with the “Nth” stage being the final stage, for instance, in a system that has three stages as specifically depicted, the Nth stage is the third stage; stage C. If the system was to have ten stages, those would be designated A through J with the Nth stage being the tenth stage; stage J.

While a reduction of microbiological flora of more than ninety-five percent is realized without secondary filtration, the optional use of 0.2μ filter 148 at the final outlet of the first or second embodiments secures further water sterilization.

While the disclosed embodiments are meant to demonstrate key features and functions of the invention, it should be understood that these embodiments are merely exemplary and that the invention should not be limited according thereto, but only according to the following claims including all equivalent interpretation entitled thereto.

We claim:

1. A device for removing undesired substances from original water comprising;
a cooling circuit for cooling said original water to or below approximately Zero degrees Celsius whereby the saturation level of the undesired substances in the original water is exceeded, thereby causing segregation of the original water into purified ice and a waste liquid containing the undesired substances;
a drain for removing said waste liquid from said purified ice;
a heating circuit for melting said purified ice into purified water;
a reservoir having an inlet for receiving the original water and an outlet for dispensing the purified water; and
a first water purity monitor disposed adjacent said outlet for monitoring a first purity level of the purified water.

2. The device of claim 1 further comprising a controller for controlling said cooling and heating circuits according to said first purity level.

3. The device of claim 1 further comprising a second water purity monitor disposed adjacent said inlet for monitoring a second purity level of the original water,

4. The device of claim 3 further comprising a controller for controlling said cooling and heating circuits according to said second purity level.

5. The device of claim 4 wherein said controller further controls said cooling and heating circuits according to a comparison of said first and second purity levels.

6. The device of claim 5 further comprising a selector for selecting a desired value of said first purity level, wherein said controller controls said cooling and heating circuits to cause said purified water to be dispensed at said desired value.

7. The device of claim 6 further comprising a mechanical filter in communication with said outlet to filter remaining impurities from said purified water.

8. The device of claim 7 further comprising a diverter for selectably causing said purified water to be dispensed either directly from said outlet or through said mechanical filter.

9. A method for removing undesired substances from original water to produce purified water and comprising;
providing a reservoir having an inlet for receiving the original water and an outlet for dispensing the purified water;
providing a first water purity monitor disposed adjacent said outlet;
cooling said original water in said reservoir to or below approximately Zero degrees Celsius whereby the saturation level of the undesired substances in the original water is exceeded, thereby causing segregation of the original water into purified ice and a waste liquid containing the undesired substances;
removing said waste liquid from said purified ice;
melting said purified ice into the purified water; and
monitoring a first purity level of the purified water with said first water purity monitor.

10. The method of claim 9 further comprising:
providing a controller for controlling said cooling and heating; and
controlling said cooling and heating with said controller according to said first purity level.

11. The method of claim 9 further comprising:
providing a second water purity monitor disposed adjacent said inlet, and monitoring a second purity level of the original water with said second water purity monitor.

12. The method of claim 11 further comprising:
providing a controller for controlling said cooling and heating; and
controlling said cooling and heating with said controller according to said second purity level.

13. The method of claim 12 further comprising:
controlling said heating and cooling with said controller according to a comparison of said first and second purity levels.

14. The method of claim 13 further comprising:
providing a selector for selecting a desired value of said first purity level;
selecting said desired level of said first purity level with said selector; and
controlling said cooling and heating with said controller to cause said purified water to be dispensed at said desired value.

15. The method of claim 14 further comprising:
providing a mechanical filter in communication with said outlet; and
filtering remaining impurities from said purified water with said mechanical filter.

16. The method of claim 15 further comprising:
providing a diverter for selectably causing said purified water to be dispensed either directly from said outlet or through said mechanical filter; and
actuating said diverter to select between causing said purified water to be dispensed directly from said outlet or causing said purified water to be dispensed through said mechanical filter;.

17. A device for removing undesired substances from original water using a closed-loop refrigeration circuit and comprising;
a cooling portion of said closed-loop refrigeration circuit for cooling said original water to or below approximately Zero degrees Celsius whereby the saturation level of the undesired substances in the original water is exceeded, thereby causing segregation of the original water into purified ice and a waste liquid containing the undesired substances;
a drain for removing said waste liquid from said purified ice;
a heating portion of said closed-loop refrigeration circuit for melting said purified ice into purified water;
a reservoir having an inlet for receiving the original water and an outlet for dispensing the purified water; and
a first water purity monitor disposed adjacent said outlet for monitoring a first purity level of the purified water.

18. The device of claim 17 further comprising a controller for controlling said cooling and heating portions according to said first purity level.

19. The device of claim 17 further comprising a second water purity monitor disposed adjacent said inlet for monitoring a second purity level of the original water,

20. The device of claim 19 further comprising a controller for controlling said cooling and heating portions according to said second purity level.

21. The device of claim 20 wherein said controller further controls said cooling and heating portions according to a comparison of said first and second purity levels.

22. The device of claim 21 further comprising a selector for selecting a desired value of said first purity level, wherein said controller controls said cooling and heating portions to cause said purified water to be dispensed at said desired value.

23. The device of claim 22 further comprising a mechanical filter in communication with said outlet to filter remaining impurities from said purified water.

24. The device of claim 23 further comprising a diverter for selectably causing said purified water to be dispensed either directly from said outlet or through said mechanical filter.

25. The device of claim 17 wherein said closed-loop refrigeration circuit contains a refrigerant and:
said heating portion comprises a compressor for heating said refrigerant by compression thereof to melt said purified ice, and
said cooling portion comprises an expansion coil for cooling said refrigerant by allowing the expansion thereof to cool the original water.

26. A system for removing undesired substances from original water comprising a first device and a final device connected in a series arrangement, said first device comprising:
a first cooling circuit for cooling the original water to or below approximately Zero degrees Celsius whereby the saturation level of the undesired substances in the original water is exceeded, thereby causing segregation of the incoming water into a first purified ice and a first waste liquid containing at least some of the undesired substances;
a first drain for removing said first waste liquid from said first purified ice;
a first heating circuit for melting said first purified ice into less impure water;
a first reservoir having a first inlet for receiving the original water and a first outlet for dispensing the less impure water to said final device; and
said final device comprising:
a final cooling circuit for cooling the less impure water to or below approximately Zero degrees Celsius whereby the saturation level of substantially the remaining undesired substances in the less impure water is exceeded, thereby causing segregation of the less impure water into a final purified ice and a final waste liquid containing the substantially the remaining undesired substances;
a final drain for removing said final waste liquid from said final purified ice;
a final heating circuit for melting said final purified ice into even less impure water;
a final reservoir having a final inlet for receiving the less impure water and a final outlet for dispensing the even less impure water.

27. The system of claim 26 further comprising a first spigot in communication with said first outlet for removing at least some of said less impure water thereat.

28. The system of claim 26 further comprising one or more intermediary devices disposed between and in liquid communication with said first and final device, each intermediary device comprising;
an intermediary cooling circuit for cooling the water from the preceding device to or below approximately Zero degrees Celsius whereby the saturation level of undesired substances in the intermediary water is exceeded, thereby causing segregation of the intermediary water into an intermediary purified ice and an intermediary waste liquid containing at least some of the undesired substances;
an intermediary drain for removing said intermediary waste liquid from said intermediary purified ice;
an intermediary heating circuit for melting said intermediary purified ice into intermediary water;
an intermediary reservoir having an intermediary inlet for receiving the water from the preceding device and an intermediary outlet for dispensing the intermediary water to the next device; wherein the less impure water from the first device is dispensed to the intermediary inlet of a first of said one or more intermediary devices and the intermediary water from the outlet of a last of said one or more intermediary devices is the even less impure water dispensed to said final device.

29. The system of claim 28 wherein each intermediary device further comprises an intermediary spigot in communication with said intermediary outlet for removing at least some of said intermediary water thereat.
